(19) United States
(12) Patent Application Publication
(10) Pub. No.: US 2011/0106459 A1
(43) Pub. Date: May 5, 2011

(54) IN-SITU OPTICAL CRACK MEASUREMENT USING A DOT PATTERN

(75) Inventors: Robert J. Christ, JR., Brentwood, NY (US); Jerrell A. Nardiello, Hicksville, NY (US); John M. Papazian, Great Neck, NY (US); Daniel R. Fridline, Coram, NY (US)

(73) Assignee: NORTHROP GRUMMAN CORPORATION, Los Angeles, CA (US)

(21) Appl. No.: 12/608,497

(22) Filed: Oct. 29, 2009

(51) Int. Cl. G06F 19/00; G01L 1/00

(52) U.S. Cl. 702/42

(57) ABSTRACT

A method of detecting cracks in an object includes: capturing a first image of a pattern of marks in a region of interest on a surface of the object; constructing a finite element model of the region of interest having nodes corresponding to the marks in the pattern; subjecting the object to a first mechanical load to produce strains in the object; capturing a second image of the pattern; computing strains in the object based on relative changes in locations of the marks in the first and second images; modifying the finite element model to produce a crack versus surface strain map; capturing a third image of the pattern; and comparing the locations of marks in the third image to the crack versus surface strain map to identify a crack in the object. An apparatus that performs the method is also provided.

### FIELD OF THE INVENTION

This invention relates to methods and apparatus for detecting cracks in structures or other objects.

### BACKGROUND OF THE INVENTION

There are many known ways to detect hidden or invisible cracks in objects. For example, the object can be broken and inspected, or the object can be subjected to various tests in a laboratory environment. However, the ability to detect cracks in an object in the field, while the object is under load, and without destroying the object, is not readily available.

There is a need for a method and apparatus for detecting hidden cracks via a non-destructive, in-situ technique.

### SUMMARY OF THE INVENTION

In a first aspect, the invention provides a method of detecting cracks in an object including: capturing a first image of a pattern of marks in a region of interest on a surface of the object; constructing a finite element model of the region of interest having nodes corresponding to the marks in the pattern; subjecting the object to a first mechanical load to produce strains in the object; capturing a second image of the pattern; computing strains in the object based on relative changes in locations of the marks in the first and second images; modifying the finite element model to produce a crack versus surface strain map; capturing a third image of the pattern; and comparing the locations of marks in the third image to the crack versus surface strain map to identify a crack in the object.

In another aspect, the invention provides an apparatus for detecting cracks in an object. The apparatus includes an image capture device for capturing first, second and third images of a pattern of marks in a region of interest on a surface of the object; and a processor for implementing a finite element model of the region of interest having nodes corresponding to the marks in the pattern, computing strains in the object based on relative changes in locations of the marks in the first and second images after the object has been subject to a mechanical load, modifying the finite element model to produce a crack versus surface strain map, and comparing the locations of marks in the third image to the crack versus surface strain map to identify a crack in the object.

### BRIEF DESCRIPTION OF THE DRAWING

The drawing is a schematic representation of an apparatus constructed in accordance with an embodiment of the invention.

### DETAILED DESCRIPTION OF THE INVENTION

This invention provides a method and apparatus for non-contact detection of cracks in an object, also referred to as a structure, a work piece, or test specimen.

In one aspect, the invention provides a system for detecting the onset of fatigue cracks in objects (e.g., aircraft, spacecraft, motor vehicles, bridges, and components thereof, etc.) by detecting changes in a dot pattern on the surface of the subject object.

The drawing is a schematic representation of a crack detection system 10 constructed in accordance with an embodiment of the invention. The system includes an imaging device, such as a video camera 12 positioned to capture images of a pattern 14 of dots or other marks on a surface of an object 16. The dot pattern can be printed or etched on the object, using for example a laser printer, ink-jet printer, laser etching, etc.

The object can be subjected to a mechanical load, resulting in deformation of the object and changes in the images captured by the video camera. Mechanical strain in the object causes the distance between dots in the pattern to change. By taking images of the dot pattern at different times, the change in the distance between the dots can be measured.

Image information is sent from the video camera (or another type of sensor, such as a still camera or a coordinate measuring device) to a computer or other processor 18 that is programmed to run mark location software. Changes in the distance between the marks are used to determine mechanical strain in the object. Using additional processing, for example finite element analysis, the surface strain can be used to detect the formation of cracks in the object. The cracks can be hidden from view, and/or of such a small size as to be invisible to an observer. The marks can be circular dots, but are not limited to any particular shape.

The processor processes the image information and produces an output that is representative of a crack in the object. The output can be displayed on a user interface 20.

In one embodiment, a two-dimensional array of circular dots is imprinted on the structure to be viewed by a video camera during the test. The camera captures a first image (also called a baseline or reference image) that includes the dots in a first, or reference, location. Then the camera takes one or more additional images that include the dots after they have been displaced by strains in the object. The processor uses the change in the distance between any two dots to calculate the strain in the test specimen.

Local strain in the structure is calculated when the system locates the center of a dot and compares a change in the relative position of that center to the center of one or more other dots.

The steps necessary to make the strain determination are as follows. Given an initial dot spacing, a baseline image is taken of all, or part, of the printed dot array. Software running on the processor will establish a file of reference locations for the dots, and then compare any two dot locations in one or more later frames to the reference values to determine strains. Two-dimensional strain measurements can be made at potentially thousands of different points across a specimen.

The concept can also be extended to include the case where the dot pattern is on a non-planar surface. The primary difference in such a system is the need to have a baseline measurement of the third dimension. This could be accomplished by taking initial measurements with a Coordinate Measuring Machine (CMM), or other device, and storing them in a lookup table for use in future state calculations. A plurality of measurements taken with a CMM would be considered to fall within the definition of an image as used in this description. Alternately, a multiple camera system could be employed to image the dot pattern and triangulate the dot positions in three dimensions.

The local strains are calculated when the system locates the center of a dot and compares its relative position to neighboring dots. The local strain field around a region of interest is determined from the localized distortion (i.e., stretch and rotation) of the dot pattern and is calibrated by comparing to the strains “measured” with a detailed finite element analysis of the structure. The finite element model is constructed with a local grid density in the undeformed configuration equivalent to the undeformed dot pattern on the structure, so that there will be a one-to-one correspondence between local deformation of the structure and that of the finite element grid which allows for calibration of actual measured deformation of the structure with respect to strains computed via the finite element model.

The finite element analysis can be accomplished using any commercially available software package capable of performing non-linear static structural analysis (such as software available from ANSYS or ABAQUS). The software should also include modeling capabilities that allow modeling of crack tip elements in the object so as to ascertain the perturbations of the local strain field under load for comparison with subsequent measurements. The basic process is outlined below:
1. A finite element model of the region of interest is constructed such that the local grid spacing on the measured surface is equivalent to the dot pattern established on the object (i.e., the nodes of the finite element model correspond to the dot pattern). This establishes a one-to-one correspondence of finite element nodes and the surface dot pattern.
2. The uncracked configuration object is subjected to a mechanical load at various levels and the deformed pattern is recorded. The deformed pattern is compared to a deformed mesh of the finite element model under the same loading conditions and the resultant finite element strains are recorded. This establishes the baseline strain distributions for uncracked configurations under various loading conditions.
3. Information representative of cracks of various sizes is then placed into the finite element model and the numerical simulations are repeated under the same loading conditions to measure the deformed mesh and strains. This allows a map of surface strain (deformed dot pattern) vs. crack size to be developed.
4. Field measurements on actual parts can then be compared to the finite element generated mapping from Step 3 to determine actual crack size in the object.

The output from the finite element model would be a table of strains vs. position for a given crack size, and the output from the experimental measurements would be a table of strains vs. positions. Ultimately, the disparity between the two sets of outputs would be displayed as some sort of contour plot, or similar, identifying the size and location of the cracks in the component.

In one aspect, the system can be used to make very localized measurements of the distortion of a strain field around a hole, or similar localized feature, that are caused by relatively small (e.g., invisible to the naked eye) fatigue cracks forming on or near that feature. As used in this description, the tetin “very localized” is defined as the region immediately around a feature of interest, such as a fastener hole, and the local region of interest would extend about 2 or 3 diameters around the hole. For a ¼″ diameter fastener, the pattern might include dots having a diameter of about 0.005″ and spaced about 0.020″ apart. The exact dimensions will depend on the particular application.

A multitude of points can be used to measure and map the strain field around the area of interest, and then determine the root cause (i.e., cracks) of any perturbations in that field via modeling. The processor can use a center of mass calculation/least square algorithm, which eliminates the need for a sharp image.

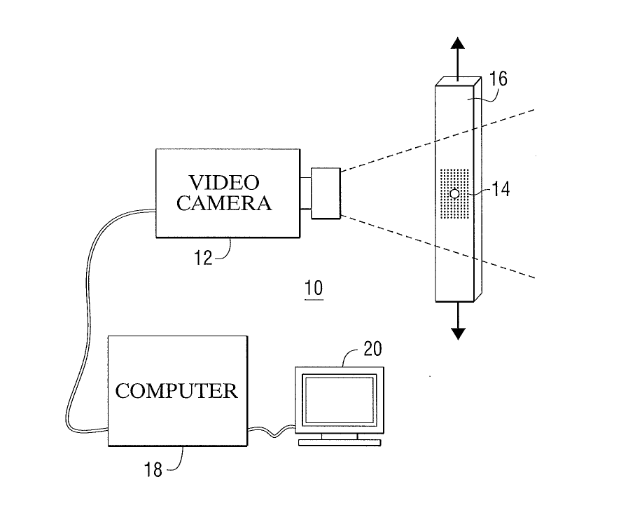

The system of FIG. 1 utilizes finite element modeling for calibration and validation of the crack detection technology. It can be designed to determine the size of the crack.

The system can detect hidden cracks in a component, by detecting changes in the strain pattern around a hole or feature of an object that are due to those cracks. It may also detect the onset of fatigue cracks in structures (e.g., aircraft, spacecraft, motor vehicles, bridges, etc.) by detecting changes in a printed dot pattern on the subject component.

An advantage of the system shown in the drawing is that it can detect cracks in an object having a hole that is filled with a fastener, thus rendering the cracks invisible unless intrusive inspection methods are employed (such as removing the fastener). On an aircraft, or other vehicle, fastener removable is not something that is easily accomplished, and is normally reserved for major teardown maintenance periods.

From the above description, it can be seen that in one aspect the invention provides a method wherein a dot pattern is imprinted on the sample around the feature of interest, and monitored optically with some type of camera or optical capture device, and the images are analyzed for changes, which can be attributed to hidden cracking. The local strains are calculated when the system locates the center of a dot and compares its relative position to neighboring dots. The local strain field around a region of interest is determined from the localized distortion (stretch and rotation) of the dot pattern and is calibrated by a detailed finite element analysis of the structure. The finite element analysis can be accomplished with a variety of commercially available software packages.

The system can detect cracks that are invisible to the naked eye by indirectly observing a strain gradient resulting from the crack. The system observes changes in a predetermined dot pattern printed on the object under study, and does so on a very localized scale so as to ascertain information about underlying cracks.

While the invention has been described in terms of several embodiments, it will be apparent to those skilled in the art that various changes can be made to the described embodiments without departing from the scope of the invention as set forth in the following claims.

What is claimed is:

1. A method of detecting cracks in an object, the method comprising:
capturing a first image of a pattern of marks in a region of interest on a surface of the object;
constructing a finite element model of the region of interest having nodes corresponding to the marks in the pattern;
subjecting the object to a first mechanical load to produce strains in the object;
capturing a second image of the pattern;
computing strains in the object based on relative changes in locations of the marks in the first and second images;
modifying the finite element model to produce a crack versus surface strain map;
capturing a third image of the pattern; and
comparing the locations of marks in the third image to the crack versus surface strain map to identify a crack in the object.

2. The method of claim 1, wherein the step of modifying the finite element model to produce a crack versus surface strain map comprises:
inserting crack information in the finite element model and simulating deformation of the pattern of marks under the first mechanical load.

3. The method of claim 1, wherein the region of interest comprises an area around a feature in the object.

4. The method of claim 3, wherein the feature comprises a hole in the object.

5. The method of claim 1, wherein the marks comprise dots having a diameter of about 0.005 inch and centers spaced at about 0.020 inch.

6. The method of claim 1, wherein the marks are arranged in a two-dimensional array.

7. The method of claim 1, wherein the marks are arranged in a three-dimensional array.

8. The method of claim 1, wherein the step of comparing the locations of marks in the third image to the surface strain map to identify a crack in the object comprises:
locating the centers of the marks in the third image; and
determining the distance between the centers of the marks in the third image and marks in the surface strain map.

9. The method of claim 1, further comprising:
producing an output having information about a crack in the object.

10. An apparatus for detecting cracks in an object, the apparatus comprising:
an image capture device for capturing first, second and third images of a pattern of marks in a region of interest on a surface of the object; and
a processor for implementing a finite element model of the region of interest having nodes corresponding to the marks in the pattern, computing strains in the object based on relative changes in locations of the marks in the first and second images after the object has been subject to a mechanical load, modifying the finite element model to produce a crack versus surface strain map, and comparing the locations of marks in the third image to the crack versus surface strain map to identify a crack in the object.

11. The apparatus of claim 10, wherein the processor inserts crack information in the finite element model and simulates deformation of the pattern of marks under the first mechanical load.

12. The apparatus of claim 10, wherein the region of interest comprises an area around a feature in the object.

13. The apparatus of claim 12, wherein the feature comprises a hole in the object.

14. The apparatus of claim 10, wherein the marks comprise dots having a diameter of about 0.005 inch and centers spaced at about 0.020 inch.

15. The apparatus of claim 10, wherein the marks are arranged in a two-dimensional array.

16. The apparatus of claim 10, wherein the marks are arranged in a three-dimensional array.

17. The apparatus of claim 10, wherein the processor locates the centers of the marks in the third image, and determines the distance between the centers of the marks in the third image and marks in the surface strain map.
